(19) United States
(12) Patent Application Publication
(10) Pub. No.: US 2025/0036934 A1
(43) Pub. Date: Jan. 30, 2025

(54) APPROXIMATE CONFUSION MATRIX FOR MULTI-LABEL CLASSIFICATION

(71) Applicant: Oracle International Corporation, Redwood Shores, CA (US)

(72) Inventors: Tomas Feith, Zurich (CH); Arno Schneuwly, Effretikon (CH); Saeid Allahdadian, Vancouver (CA); Matteo Casserini, Zurich (CH); Felix Schmidt, Baden-Dattwil (CH)

(21) Appl. No.: 18/227,758

(22) Filed: Jul. 28, 2023

(51) Int. Cl. G06N 3/08

(52) U.S. Cl. CPC G06N 3/08

(57) ABSTRACT

Herein is validation of a trained classifier based on novel and accelerated estimation of a confusion matrix. In an embodiment, a computer hosts a trained classifier that infers, from many objects, an inferred frequency of each class. An upscaled magnitude of each class is generated from the inferred frequency of the class. An integer of each class is generated from the upscaled magnitude of the class. Based on those integers of the classes and a target integer for each class, counts are generated of the objects that are true positives, false positives, and false negatives of the class. Based on those counts, an estimated total of true positives, false positives, false negatives are generated that characterizes fitness of the trained classifier. In an embodiment, those counts and totals are downscaled to be fractions from zero to one.

### FIELD OF THE INVENTION

The present invention relates to validation of a machine learning (ML) classifier. Herein is fitness measurement by novel estimation of a confusion matrix.

### BACKGROUND

Performance metrics are required to evaluate classification models. Those metrics should have a clear, human interpretable meaning. Models for multi-label classification may produce a probability distribution that may be compared with correct labels. However, metrics such as cross-entropy, Kullback-Leibler (KL) divergence, or Wasserstein distance take values in a range [0, infinity) that is a range with no upper bound. Even for an individual inference, various multidimensional distance metrics are not ergonomic because the interpretation of the score obtained is unclear.

Previous attempts to compute more interpretable metrics decompose the probability distributions into independent binary problems, one for each class. However, that approach decouples the classes, and neglects interactions between them. Additionally, a binary problem only takes into account class existence. A binary problem is unable to capture class frequency from an input, which leads to a less representative performance metric. These shortcomings may make validation difficult or difficult to explain.

### BRIEF DESCRIPTION OF THE DRAWINGS

In the drawings:

FIG. 1 is a block diagram that depicts an example computer that validates a trained classifier using fitness measurement by novel estimation of a multiclass confusion matrix;

FIG. 2 is a block diagram that depicts an example computer that hosts a trained classifier that generates inferred frequencies as an inferred encoding of a parse tree according to a corpus vocabulary;

FIG. 3 is a flow diagram that depicts an example computer process that validates a trained classifier using fitness measurement by estimation of a multiclass confusion matrix;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein is validation of a machine learning (ML) classifier based on fitness measurement by novel estimation of a confusion matrix. In the context of multilabel classification, the goal is for a classification model to process an input and produce a predicted distribution identical to the target distribution associated with the input. This approach takes as input a correct target distribution, a possibly inaccurately predicted distribution, and a normalization factor. An embodiment may also take a weight vector that assigns a weight to each class. The same normalization factor is used to scale both the predicted and target distributions and, with rounding, the predicted distribution is converted into an integer distribution. Although imprecise, validation metric calculation based on integer distributions is accelerated herein.

Integer calculations herein are a novel and accelerated way to populate a confusion matrix that can be used to calculate a scalar validation metric and can also be used to explain, in a more meaningful way, validation results. The confusion matrix herein has a novel internal configuration in which three (i.e. false positive, true positive, and false negative) of its four values are estimates, and true negative is always undefined.

With M classes and N predictions, the total number of true negatives grows as O(MN). On the other hand, the total number of true positives, false positives, and false negatives all grow as O(N). Because for typical applications M>>N, a labelling of true negatives would overwhelm the interpretability of the true positives, false positives, and false negatives that always correspond to too small of a percentage of the predictions. Any validation metric that is not based on true negatives may be calculated from this novel estimated confusion matrix, such as any or all of the following validation metrics: true positive rate (TPR), positive predictive value (PPV), false negative rate (FNR), false discovery rate (FDR), critical success index (CSI), F1 score, and Fowlkes-Mallows index (FM). All of those metrics are accelerated herein.

This approach improves model interpretability by providing a set of intuitive and interpretable metrics (true positives, false positives, false negatives). This approach has at least the following novel aspects.
This is a new way to compare two distributions in the context of multilabel classification. In contrast with other metrics such as Kullback-Leibler (KL) divergence or Wasserstein distance, the metrics obtained from the approximate confusion matrix herein have a straightforward interpretation.
This approach does not provide one single metric (e.g. distance), but rather a set of three synergistic metrics (true positives, false positives, false negatives) which give more insight into the model performance.
These metrics have a more interpretable scalar value (90% true positives is clearer than a KL divergence of 0.5).

In an embodiment, a computer hosts a trained classifier that infers, from many objects, an inferred frequency of each class of at least three classes. In an embodiment, this same approach that is presented herein as handling at least three classes may instead handle only two class (i.e. binary classification). Three classes are used herein to demonstrate that this approach is not limited to binary classification.

A respective upscaled magnitude of each class is generated from the inferred frequency of the class. A respective integer of each class is generated from the upscaled magnitude of the class. Based on those integers of the classes and a target integer respectively for each class, the following are estimated: a count of the many objects that are true positives of the class, a count of the many objects that are false positives of the class, and a count of the many objects that are false negatives of the class. Based on the counts of true positives of the classes, an estimated total of true positives is generated that characterizes fitness of the trained classifier. Based on the counts of false positives of the classes, an estimated total of false positives is generated that characterizes the fitness of the trained classifier. Based on the counts of false negatives of classes, an estimated total of false negatives is generated that characterizes fitness of the trained classifier.

### 1.0 Example Computer

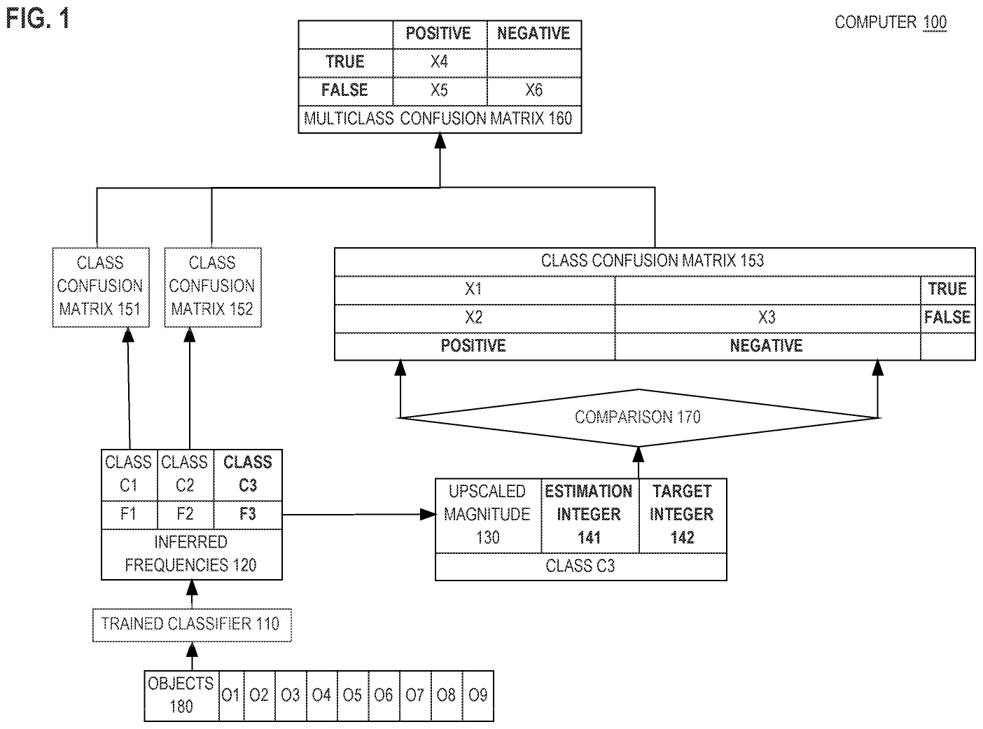

FIG. 1 is a block diagram that depicts an example computer 100, in an embodiment. Computer 100 validates (i.e. tests) trained classifier 110 using fitness measurement by novel estimation of multiclass confusion matrix 160. Computer 100 may be one or more of a rack server such as a blade, a mainframe, a personal computer, or a virtual machine.

### 1.1 Example Classification

Trained classifier 110 is a machine learning (ML) model that was already trained for multiclass (i.e. multilabel) classification of individual objects such as objects O1-O9 that occur within an input such as objects 180. The classification is based on classes C1-C3 that may or may not be orthogonal (i.e. not mutually exclusive). For demonstration in this example, classes C1-C3 are mutually exclusive such that object O1 may belong to none or exactly one of classes C1-C3, and objects 180 may contain a mix of none, one, some, or all of classes C1-C3.

For example during validation, trained classifier 110 may accept objects 180 as input (e.g. in a feature vector), which causes trained classifier 110 to infer (i.e. generate) frequencies F1-F3 respectively for classes C1-C3. Each of inferred frequencies 120 is at least zero and possibly inaccurate.

Objects 180 represent aspects of a detailed item such as a log message, a database record, a semi-structured document such as JavaScript object notation (JSON) or extensible markup language (XML), or a data structure such as a parse tree.

### 1.2 Example Confusion Matrix and Validation

During validation as discussed later herein, computer 100 may estimate class confusion matrices 151-153 for respective classes C1-C3 based on inferred probabilities 120. In an embodiment, all of inferred probabilities 120 are multiplied by a same single multiplicand (not shown) to calculate respective upscaled magnitudes, including upscaled magnitude 130 for class C3 as shown. For example, upscaled magnitude 130 may be a multiplicative product of inferred frequency F3 times an upscaling multiplicand that is discussed later herein. Because the upscaling multiplicand is a positive integer, the upscaled magnitude may be an increased magnitude.

Inferred frequencies 120 are processed by class. For example as shown, inferred frequency F3 is processed for class C3 to generate upscaled magnitude 130, and other upscaled magnitudes (not shown) are generated for other classes C1-C2. Class confusion matrix 153 is estimated (i.e. generated) based on inferred frequency F3 but not based on other inferred frequencies F1-F2 that are for other classes C1-C2.

### 1.3 Example Estimation of Confusion Matrix

Estimation integer 141 is generated from upscaled magnitude 130. In various embodiments, estimation integer 141 is generated by rounding respective upscaled magnitude 130, such as by rounding always up or always down to an adjacent integer. For example, 5.6 rounds up to six or down to five. An embodiment may round to a nearest integer, which rounds up for some values and down for other values.

In the state of the art, a label might be a known correct binary classification (i.e. class positive or class negative) of a given single object such as object O1. Unlike the state of the art, herein it is classes C1-C3 that are labeled for objects 180. Each of classes C1-C3 has a respective class label for objects 180 that is a known correct count (e.g. frequency) of objects 180 that belong to that class. Herein, a class label is a count that does not necessarily identify which of objects O1-O9. In other words, objects O1-O9 are not necessarily individually labeled as class positive or class negative herein. Herein, a classification might be class negative (e.g. not class C3). Numbers 120, 130, 141-142, and X1-X6 are never numeric negative (i.e. below zero).

### 1.4 Upscaling Multiplicand and Integer Differencing

The same upscaling multiplicand may be used in a same way to upscale both of: inferred frequency F3 and the label frequency of class C3 of objects 180. Herein a label frequency may be referred to as a class frequency. Because all label frequencies and the upscaling multiplicand are integers, the multiplicative product of a label frequency times the upscaling multiplicand always is an integer too. For example as follows, target integer 142 is an upscaled label frequency.

Because an upscaled label frequency is always an integer, target integer 142 has no imprecision such as a rounding error. Whereas, estimation integer 141 may have a rounding error or an inference error or both. Due to error, integers 141-142 may differ by some arithmetic difference that too is always an integer. When integers 141-142 are identical, their difference is zero, which indicates a correct (i.e. true) inference that includes a correct count (i.e. frequency).

### 1.5 Accelerated Generation of Confusion Matrix

However, a zero or nonzero difference is not individually interpreted herein as true (i.e. accurate) or false. Herein, none of numbers 120, 130, and 141 are individually interpreted as true or false, which is novel. Herein, none of numbers 120, 130, and 141 are necessarily individually detected as class positive or class negative, which also is novel. Because such individual determinations may be absent, confusion matrices herein are estimated.

By sacrificing exactness during estimation, generation of one or more confusion matrices is accelerated beyond the state of the art. Because confusion matrices are intuitive, ergonomics (i.e. human interpretability) of validation results herein is improved compared to oversimplifying and highly technical validation metrics such as KL-divergence. Thus, comparison 170 does not detect whether an individual one of integers 141-142 indicates class positive or class negative.

Unlike other validation approaches, novel validation herein does not use a detection threshold for classification. Herein, there is no need for a detection threshold that is a predefined probability above the probabilities of class negatives and below the probabilities of class positives. The approach herein works even if a detection threshold is unimplemented or undefined. Thus, comparison 170 does not use a detection threshold.

### 1.6 Internal Configuration of Confusion Matrix

Estimated class confusion matrix 153 is generated for class C3 from integers 141-142 that are shown bold to indicate that only integers 141-142 are used to generate class confusion matrix 153. Likewise, class confusion matrices 151-152 are generated from integers (not shown) of respective classes C1-C2. In other words, how many classes C1-C3 is how many class confusion matrices are generated.

Class confusion matrices herein are a novel kind of binary confusion matrix because a class confusion matrix effectively has only two classes that are class positive (e.g. class C3 as shown) and class negative (e.g. not class C3). A class confusion matrix logically is a two by two matrix that is two (i.e. binary class shown as positive and negative, and veracity shown as true and false) dimensional and can store four (i.e. true positive, true negative, false negative, and false positive) numeric measurements (e.g. calculated values).

Class confusion matrix 153 has a novel internal configuration in which three (i.e. false positive, true positive, and false negative) of its four values are estimates, and true negative is always undefined. Each of the three defined values is a number that is based on comparison 170 that may operate as follows.

### 1.7 Example Pseudocode

The following is a discussion of three (top, middle, and bottom) for loops in the following example pseudocode, and the middle for loop is an example implementation of comparison 170. The example pseudocode has the following inputs.
Target distribution t is all class labels (i.e. class frequencies of objects 180) as discussed earlier herein.
Predicted distribution p is inferred frequencies 120.
Scale factor N is the upscaling multiplicand discussed earlier herein.
Number of classes C is a count of all classes C1-C3 (e.g. three).
Class weights w contains a respective weight for each of classes C1-C3 as discussed later herein.

Here is the example pseudocode.

| 1: | Let t′, p′ be vectors of length C | |
|---|---|---|
| 2: | for i = 1, ..., C | [symbol] Denormalize frequencies |
| 3: | ti′ = ti × N | |
| 4: | pi′ = round(pi × N) | |
| 5: | end for | |
| 6: | Let TP, FP, FN be vectors of length C | |
| 7: | for i = 1, ..., C | [symbol] Compute true positives, false positives, false negatives per class |
| 8: | TPi = min(ti′, pi′) | |
| 9: | FPi = max(pi′ − ti′, 0) | |
| 10: | FNi = max(ti′ − pi′, 0) | |
| 11: | end for | |
| 12: | TP = 0, FP = 0, FN = 0 | |
| 13: | for i = 1, ..., C | [symbol] Aggregate metrics according to weights |

| | |
|---|---|
| 14: | TP = TP + wi · TPi |
| 15: | FP = FP + wi · FPi |
| 16: | FN = FN + wi · FNi |
| 17: | end for |

The example pseudocode has the following outputs.
Aggregate true positives TP is tally X4 in multiclass confusion matrix 160 as discussed later herein.
Aggregate false positives FP is tally X5 in multiclass confusion matrix 160 as discussed later herein.
Aggregate false negatives FN is tally X6 in multiclass confusion matrix 160 as discussed later herein.

Although referred to herein as counts, tallies X1-X6 may or may not be downscaled to be fractions from zero to one, depending on the embodiment, such as discussed later herein.

### 1.8 Top for Loop

In the example pseudocode, the top (i.e. lines 2-5) for loop calculates integers 141-142 for class C3 and other integers for other classes C1-C2.

### 1.9 Middle for Loop

The middle (i.e. lines 7-11) for loop uses comparison 170 to measure unweighted contributions of objects 180 to tallies X1-X3 in class confusion matrix 153. In the state of the art, the individual elements (i.e. numbers) in a confusion matrix are mutually exclusive possibilities that object O1 may increase. That is, object O1 increases exactly one element of a binary confusion matrix in the state of the art.

For example in the state of the art, object O1 cannot increase both of: a) true positive and b) either false positive or false negative. Whereas, object O1 in the novel middle for loop with novel comparison 170 might increase both of: a) tally X1 (i.e. true positive) and b) either tally X2 (i.e. false positive) or X3 (i.e. false negative). For example with object O1 in the middle for loop, each of line 8 and exactly one of lines 9-10 may evaluate to a respective nonzero (i.e. numerically positive integer).

In the state of the art, object O1 must increase one element of a binary confusion matrix. Whereas, object O1 in the novel middle for loop with novel comparison 170 might not increase any element in class confusion matrix 153. For example, each of lines 8-10 may evaluate to a respective zero in the middle for loop with objects 180.

In the state of the art, object O1 might increase the true negative element in a binary confusion matrix. Whereas, the true negative element is undefined in novel class confusion matrix 153, and object O1 in the novel middle for loop with novel comparison 170 never increases the true negative element in novel class confusion matrix 153.

The following internal variables in the middle for loop have the following meanings when internal variable i indicates class C3.
TPi is tally X1 in class confusion matrix 153.
FPi is tally X2 in class confusion matrix 153.
FNi is tally X3 in class confusion matrix 153.

### 1.10 Bottom for Loop

The bottom (i.e. lines 13-17) for loop performs weighting (i.e. multiplicatively scales) of the increase(s) to: a) tally(s) X1 and/or b) tally X2 or X3. Each of classes C1-C3 may have its own (e.g. distinct) weight. Example initialization of weights is discussed later herein.

The bottom for loop sums the weighted increases of all classes. That is, the bottom for loop sums corresponding elements of class confusion matrices 151-153 to generate corresponding elements of multiclass confusion matrix 160. For example, tally X1 and the true positive tallies in class confusion matrices 151-152 are summed to generate tally X4 in multiclass confusion matrix 160.

If each of objects O1-O9 belongs to at most one class or exactly one class, then true negatives might predominate (i.e. exceeding half of all inferences) despite being un-estimated. In that case, if tallies X4-X6 range from zero to one, then tallies X4-X6 sum to less than half (i.e. 0.5).

Any or all of the tally elements in any or each of confusion matrices 151-153 and 160 may be or contribute to a validation metric. Any validation metric that is not based on true negatives may be calculated from any or each of confusion matrices 151-153 and 160. For example, any or all of the following validation metrics may be calculated from any or each of confusion matrices 151-153 and 160: true positive rate (TPR), positive predictive value (PPV), false negative rate (FNR), false discovery rate (FDR), critical success index (CSI), F1 score, and Fowlkes-Mallows index (FM). For example, a validation metric may be compared to a predefined threshold to detect success or failure of validation of trained classifier 110. In an embodiment, trained classifier 110 is a single artificial neural network (ANN).

### 2.0 Example Special Application

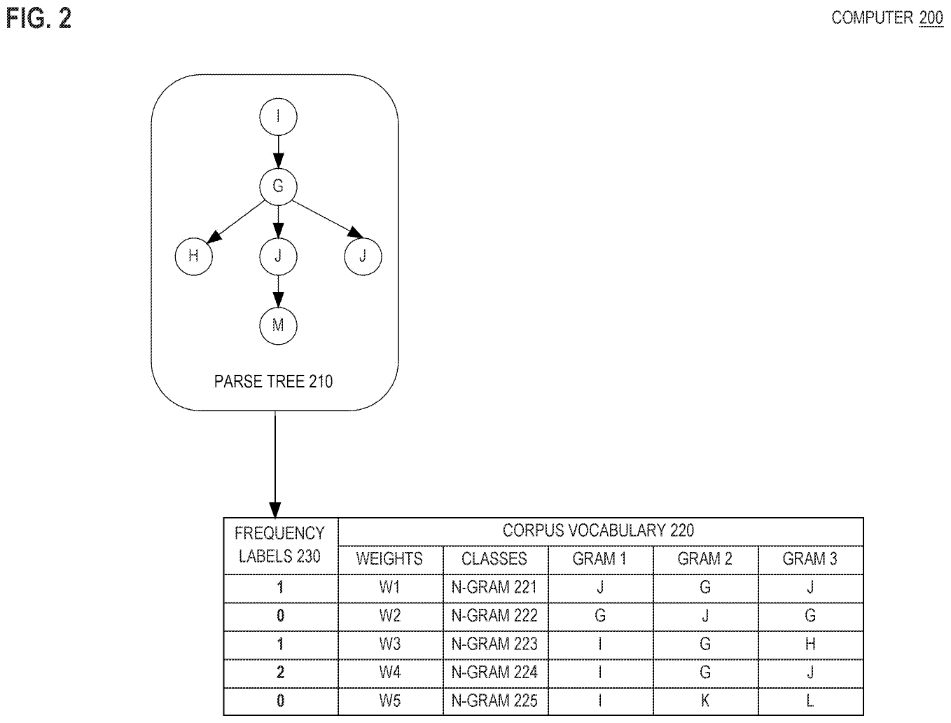

FIG. 2 is a block diagram that depicts an example computer 200, in an embodiment. Computer 200 may be an implementation of computer 100, and trained classifier 110 in computer 200 can generate inferred frequencies 120 as a possibly-inaccurate, fixed-size, dense, lossy, inferred encoding of parse tree 210 according to corpus vocabulary 220.

A training corpus may consist of many source logics of a same formal language such as a programing language, scripting language, or database language such as structured query language (SQL). A respective parse tree may be generated to represent each source logic. Parse tree 210 represents one source logic. For example, parse tree 210 may represent one SQL statement or a lexical block (e.g. subroutine body) that contains a sequence of logic statements.

### 2.1 N-Grams in Example Parse Tree

Herein, a gram is a node in a parse tree. For example, parse tree 210 contains six grams, some of which are repeated. For example, there are two J grams in parse tree 210.

An n-gram is any traversal path of length n in a parse tree. For example in parse tree 210, the path from root gram I to leaf gram M has a length of four grams (I, G, J, and M), and that path is a 4-gram.

### 2.2 Example Corpus Vocabulary

In the shown example, corpus vocabulary 220 consists of n-grams 221-225 that all are 3-grams. For example, n-grams 221-225 may be selected as the five most frequent 3-grams in the training corpus. The training corpus may contain too many distinct n-grams, many of which are not the five most frequent and thus are excluded from corpus vocabulary 220. For example, G-J-M is a 3-gram in parse tree 210 that either does not occur in the training corpus or occurs too infrequently in the training corpus to be included in corpus vocabulary 220. For example, gram M may or may not occur in the training corpus.

Although the shown links that interconnect the grams in parse tree 210 are shown with arrowheads to indicate direction, various embodiments may treat links as directed or, as follows, undirected. For example in corpus vocabulary 220 is n-gram 221 that occurs in parse tree 210 only if links are treated as undirected.

### 2.3 Example Classes

Each n-gram in corpus vocabulary 220 is a distinct class, and frequency labels 230 are class labels, as discussed earlier herein, for the classes of 3-grams in parse tree 210. Some or all of the 3-grams in parse tree 210 are shown as objects 180 in FIG. 1, and each of objects O1-O9 is a 3-gram that occurs in parse tree 210. For example, object O3 may be an occurrence of n-gram 223 that is a path that may or may not occur in parse tree 210 and that traverses from gram I to gram G to gram H. If those grams G-I instead occur in a different sequential ordering, then that would be a different n-gram. In other words, an n-gram is a particular sequence of grams.

N-grams 221-225 herein are classes similar to classes C1-C3. Depending on the context herein, n-grams may be treated in either of two ways. In a context that refers to the extent of all classes, classes C1-C3 as a set is herein synonymous with n-grams 221-225 as a set. In a context that handles an individual class, classes C1-C3 directly correspond only to n-grams 221-223. In either context, an n-gram in corpus vocabulary 220 is a class. For example, n-gram 223 may be an embodiment of class C3.

### 2.4 Frequency Labels for Individual Parse Tree

As shown in frequency labels 230, the known correct frequency of n-gram 224 is two for parse tree 210. In an embodiment, computer 200 populates frequency labels 230 as class labels of parse tree 210, even if parse tree 210 is new and not in the training corpus. For example, corpus vocabulary 220 may be based on a training corpus, and parse tree 210 may occur in a validation corpus that does not overlap with the training corpus.

Parse tree 210 might contain a 3-gram that does not occur in the training corpus or that occurs too infrequently in the training corpus to be included in corpus vocabulary 220, or gram M might not occur in the training corpus. Such superficial deficiencies of the training corpus do not affect robust techniques herein. For example, it does not matter that frequency labels 230 contains zeros for n-grams 222 and 225.

In the shown embodiment having only undirected paths in corpus vocabulary 220, the reverse of an undirected path is not an additional path. Thus, the frequency of n-gram 221 is only one. A gram occurs at most once in a path unless the gram repeats in parse tree 210, such as gram J. Thus, the frequency of n-gram 222 is only zero.

### 2.5 Confusion Matrix and Validation of Individual Parse Tree

The shown frequency of n-gram 223 is one, which is a label frequency that may be multiplied by the upscaling multiplicand to generate target integer 142 as discussed earlier herein. In an embodiment, the upscaling multiplicand is a count of one of: a) distinct n-grams in parse tree 210, b) distinct n-grams that each is in both of parse tree 210 and corpus vocabulary 220, c) (e.g. duplicate) n-grams in parse tree 210, d) n-grams that each is in both of parse tree 210 and corpus vocabulary 220, e) a count of nonzero labels in frequency labels 230, or f) a sum of frequency labels 230. Thus, the upscaling multiplicand may be based on objects 180 from parse tree 210.

In that way, a respective target integer for each class in corpus vocabulary 220 may be generated from frequency labels 230. Likewise, trained classifier 110 may accept parse tree 210 as an embodiment of objects 180 to infer (i.e. generate) inferred frequencies 120 that contains one frequency for each of n-grams 221-225 that are the distinct classes in corpus vocabulary 220. For example as discussed earlier herein, upscaled magnitude 130 may be generated for n-gram 223 in parse tree 210, and then estimation integer 141 may be generated for n-gram 223 in parse tree 210.

In that way computer 200 may, as discussed earlier herein, use frequency labels 230, inferred frequencies 120, and comparison 170 to generate class confusion matrix 153 for n-gram 223 in parse tree 210. Also in that way, computer 200 may generate a respective class confusion matrix for each of n-grams 221-225 from which to generate multiclass confusion matrix 160.

### 2.6 Class Weighting and Class Imbalance

As discussed earlier herein, only n-grams that frequently occur in the training corpus are included in corpus vocabulary 220. In an embodiment, weights W1-W5 are recorded respective inverse frequencies of n-grams 221-225 in the training corpus. An inverse frequency is the reciprocal (i.e. multiplicative inverse) of a frequency, and the inverse frequency is naturally ranging from zero to one. Herein, division by zero to generate a weight causes a predefined nonzero (e.g. large or maximum definable) weight. In an embodiment, none of weights W1-W5 is below zero, and weights W1-W5 sum to one.

Population of class confusion matrix 153 for n-gram 223 in parse tree 210 entails generating tallies X1-X3 as discussed earlier herein. N-gram 223 in parse tree 210 in the middle for loop with comparison 170 might, as discussed earlier herein, cause distinct respective increases to both tallies X1-X2. Weight W3 may be used as a downscaling multiplicand times any unweighted increase to generate a weighted increase to any of tallies X1-X3, although this downscaling multiplicand is not the upscaling multiplicand discussed earlier herein. In an embodiment, weighted downscaling compensates for class imbalance in the training corpus, such as when weights W1-W2 have different orders of magnitude.

### 3.0 Example Validation Estimation Process

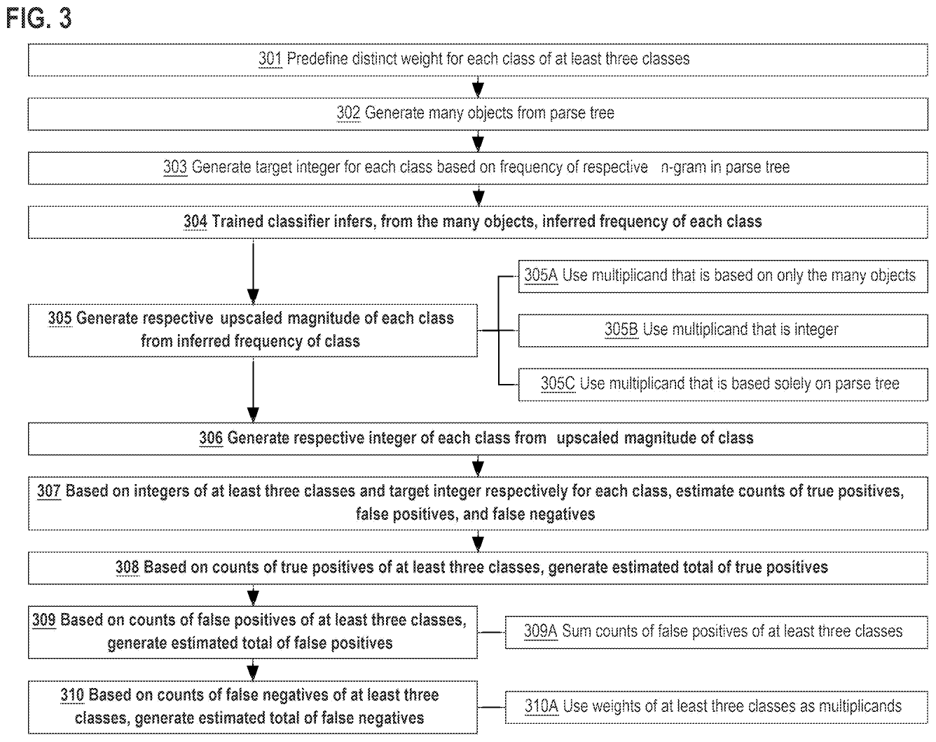

FIG. 3 is a flow diagram that depicts an example process that any computer herein may perform to validate (i.e. test) trained classifier 110 using fitness measurement by novel estimation of multiclass confusion matrix 160. The example pseudocode earlier herein may be an implementation of the process of FIG. 3. FIG. 3 is discussed with reference to FIGS. 1-2 and the example pseudocode earlier herein.

The process of FIG. 3 implements two special algorithms. The first algorithm entails steps 304-310 that are shown bold to indicate that steps 304-310 are generalized and reusable in various embodiments. The second algorithm includes the first algorithm and additional steps 301-303 and sub-steps 305A-C, 309A, and 310A that are dedicated to special applications that include parse tree encoding and compensation for class imbalance. In some embodiments, any or all of additional steps 301-303 and sub-steps 305A-C, 309A, and 310A are optional, unimplemented, or replaced by comparable steps for other applications.

Preparatory step 301 identifies corpus vocabulary 220 and predefines distinct weights W1-W5 respectively for n-grams 221-225 as discussed earlier herein. These weights are used later herein.

Step 302 obtains (e.g. by parsing logic or other text) parse tree 210 and generates objects O1-O9 as 3-grams from parse tree 210 as discussed earlier herein.

Step 303 generates a target integer for each of n-grams (i.e. classes) 221-225 based on a respective frequency label of the n-gram in parse tree 210. For example in FIG. 2, the shown frequency of n-gram 223 is one, which is a label frequency that step 303 may multiply by the upscaling multiplicand to generate target integer 142 as discussed earlier herein.

In step 304, trained classifier 110 infers, from objects 180, inferred frequencies 120 as discussed earlier herein.

In a general way, step 305 generates a respective upscaled magnitude of each of classes C1-C3 from inferred frequencies 120 as discussed earlier herein. For example as discussed earlier herein, in step 305, upscaled magnitude 130 may be generated for n-gram 223 in parse tree 210, and then estimation integer 141 may be generated for n-gram 223 in parse tree 210.

Various embodiments of step 305 may implement none, one, some, or all of sub-steps 305A-C. For step 305 there may be only one upscaling multiplicand that is shared with sub-steps 305A-C that each use the same multiplicand in a respective distinct special way as follows. Sub-step 305A uses an upscaling multiplicand that is based solely on objects 180 as discussed earlier herein and not based on other data. Sub-step 305B uses an upscaling multiplicand that is an integer as discussed earlier herein. In various embodiments, in sub-steps 305A-B, the upscaling multiplicand does not depend on how many are classes C1-C3. Sub-step 305C uses an upscaling multiplicand that is based solely on parse tree 210 as discussed earlier herein and not based on other data.

Step 306 generates a respective integer of each class from the upscaled magnitude of the class. For example, step 306 may generate estimation integer 141 for n-gram 223 in parse tree 210 as discussed earlier herein.

Based on integers of classes C1-C3 and a target integer respectively for each class, step 307 estimates counts of true positives, false positives, and false negatives for the class. For example, step 307 may generate tallies X1-X3 for n-gram 223 in parse tree 210 as discussed earlier herein.

Based on counts of true positives of classes C1-C3, step 308 generates tally X4 that is an estimated total of true positives as discussed earlier herein.

Based on counts of false positives of classes C1-C3, in a general way, step 309 generates tally X5 that is an estimated total of false positives as discussed earlier herein. Sub-step 309A, if implemented, sums counts of false positives of classes C1-C3.

Based on counts of false negatives of at least three classes, in a general way, step 310 generates tally X6 that is an estimated total of false negatives as discussed earlier herein. Sub-step 310A, if implemented, uses weights W1-W5 as downscaling multiplicands as discussed earlier herein. As discussed earlier herein, an embodiment of the process of FIG. 3 may instead work when there are only two classes (i.e. binary classification). A count of multiple classes does not affect the techniques herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

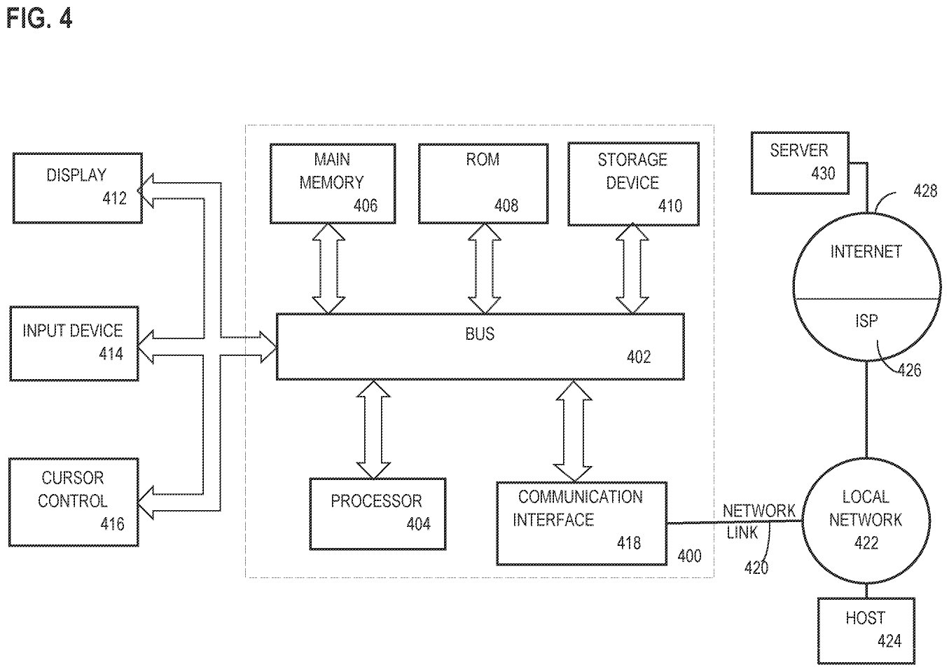

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

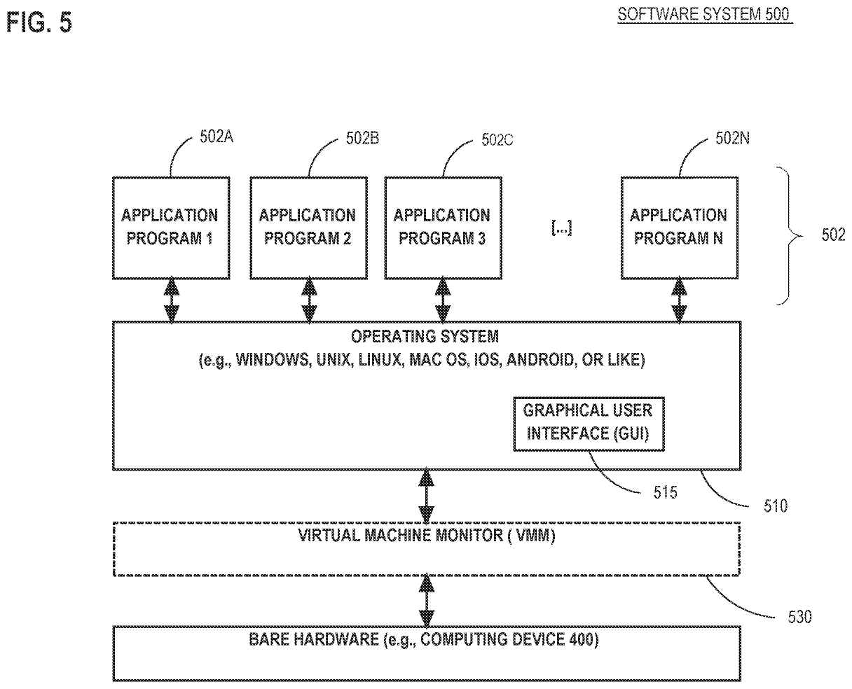

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2 (1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
inferring, by a trained classifier, from a plurality of objects, an inferred frequency of each class of at least three classes;
generating a respective upscaled magnitude of each class of the at least three classes from the inferred frequency of the class;
generating a respective integer of each class of the at least three classes from the upscaled magnitude of the class;
estimating, based on said integers of the at least three classes and a target integer respectively for each class of the at least three classes:
a count of the plurality of objects that are true positives of the class,
a count of the plurality of objects that are false positives of the class, and
a count of the plurality of objects that are false negatives of the class;
generating, based on the counts of true positives of the at least three classes, an estimated total of true positives that characterizes fitness of the trained classifier;
generating, based on the counts of false positives of the at least three classes, an estimated total of false positives that characterizes the fitness of the trained classifier; and
generating, based on the counts of false negatives of the at least three classes, an estimated total of false negatives that characterizes fitness of the trained classifier;
wherein the method is performed by one or more computers.

2. The method of claim 1 wherein said generating the estimated total of false positives comprises summing the counts of false positives of the at least three classes.

3. The method of claim 1 wherein said generating the upscaled magnitude comprises using a particular multiplicand selected from a group consisting of a multiplicand that is based on solely on the plurality of objects and an integer multiplicand.

4. The method of claim 3 wherein the particular multiplicand is not based on a count of the at least three classes.

5. The method of claim 1 wherein:
the method further comprises predefining a distinct weight for each class of the at least three classes; and
said generating the estimated total of false negatives comprises using the weights of the at least three classes as multiplicands.

6. The method of claim 5 wherein at least one selected from a group consisting of:
the weight of each class of the at least three classes is less than one, and
the weights of the at least three classes sum to one.

7. The method of claim 1 wherein said generating the integers of the at least three classes comprise one selected from a group consisting of: rounding up, rounding down, and rounding to respective nearest integers.

8. The method of claim 1 further comprising:
generating the plurality of objects from a parse tree; and
generating the target integer for each class of the at least three classes based on a frequency of a respective n-gram in the parse tree.

9. The method of claim 8 wherein said generating the upscaled magnitude comprises using a multiplicand that is based solely on the parse tree.

10. The method of claim 1 wherein:
the estimated total of true positives, the estimated total of false positives, and the estimated total of false negatives are fractions that are less than one;
a sum of said fractions would be less than half.

11. The method of claim 1 wherein the trained classifier is a single neural network.

12. One or more non-transitory computer-readable media storing instructions that, when executed by one or more processors, cause:
inferring, by a trained classifier, from a plurality of objects, an inferred frequency of each class of at least three classes;
generating a respective upscaled magnitude of each class of the at least three classes from the inferred frequency of the class;
generating a respective integer of each class of the at least three classes from the upscaled magnitude of the class;
estimating, based on said integers of the at least three classes and a target integer respectively for each class of the at least three classes:
a count of the plurality of objects that are true positives of the class,
a count of the plurality of objects that are false positives of the class, and
a count of the plurality of objects that are false negatives of the class;
generating, based on the counts of true positives of the at least three classes, an estimated total of true positives that characterizes fitness of the trained classifier;
generating, based on the counts of false positives of the at least three classes, an estimated total of false positives that characterizes the fitness of the trained classifier; and
generating, based on the counts of false negatives of the at least three classes, an estimated total of false negatives that characterizes fitness of the trained classifier;
wherein the method is performed by one or more computers.

13. The one or more non-transitory computer-readable media of claim 12 wherein said generating the estimated total of false positives comprises summing the counts of false positives of the at least three classes.

14. The one or more non-transitory computer-readable media of claim 12 wherein said generating the upscaled magnitude comprises using a particular multiplicand selected from a group consisting of a multiplicand that is based on solely on the plurality of objects and an integer multiplicand.

15. The one or more non-transitory computer-readable media of claim 14 wherein the particular multiplicand is not based on a count of the at least three classes.

16. The one or more non-transitory computer-readable media of claim 12 wherein:
the instructions further cause predefining a distinct weight for each class of the at least three classes; and
said generating the estimated total of false negatives comprises using the weights of the at least three classes as multiplicands.

17. The one or more non-transitory computer-readable media of claim 16 wherein at least one selected from a group consisting of:
the weight of each class of the at least three classes is less than one, and
the weights of the at least three classes sum to one.

18. The one or more non-transitory computer-readable media of claim 12 wherein said generating the integers of the at least three classes comprise one selected from a group consisting of: rounding up, rounding down, and rounding to respective nearest integers.

19. The one or more non-transitory computer-readable media of claim 12 wherein the instructions further cause:
generating the plurality of objects from a parse tree; and
generating the target integer for each class of the at least three classes based on a frequency of a respective n-gram in the parse tree.

20. The one or more non-transitory computer-readable media of claim 19 wherein said generating the upscaled magnitude comprises using a multiplicand that is based solely on the parse tree.

21. A method comprising:
inferring, by a trained classifier, from a plurality of objects, an inferred frequency of each class of a plurality of classes;
generating a respective upscaled magnitude of each class of the plurality of classes from the inferred frequency of the class;
generating a respective integer of each class of the plurality of classes from the upscaled magnitude of the class;
estimating, based on said integers of the plurality of classes and a target integer respectively for each class of the plurality of classes:
a count of the plurality of objects that are true positives of the class,
a count of the plurality of objects that are false positives of the class, and
a count of the plurality of objects that are false negatives of the class;
generating, based on the counts of true positives of the plurality of classes, an estimated total of true positives that characterizes fitness of the trained classifier;
generating, based on the counts of false positives of the plurality of classes, an estimated total of false positives that characterizes the fitness of the trained classifier; and
generating, based on the counts of false negatives of the plurality of classes, an estimated total of false negatives that characterizes fitness of the trained classifier;
wherein the method is performed by one or more computers.
